(19) United States
(12) Patent Application Publication
(10) Pub. No.: US 2005/0087609 A1
(43) Pub. Date: Apr. 28, 2005

(54) Contactless label and method for its manufacture

(75) Inventor: Philippe Martin, Beaune (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Tagsys, a corporation of France, La Penne-sur Huveaune (FR)

(21) Appl. No.: 10/974,294

(22) Filed: Oct. 27, 2004

Related U.S. Application Data
(63) Continuation of application No. PCT/FR03/01331, filed on Apr. 28, 2003.

(30) Foreign Application Priority Data
Apr. 30, 2002 (AU) PS2011

(51) Int. Cl. G06K 19/06

(52) U.S. Cl. 235/492

(57) ABSTRACT

A contactless RF-ID label including an antenna and a computer chip, wherein the antenna extends in three spatial directions.

### RELATED APPLICATION

This is a continuation of International Application No. PCT/FR03/01331, with an international filing date of Apr. 28, 2003 (WO 03/094104, published Nov. 13, 2003), which is based on Australian Provisional Patent Application No. PS 2011, filed Apr. 30, 2002.

### FIELD OF THE INVENTION

This invention pertains to the field of electronic labels enabling contactless reading of information and which are read remotely by a questioning/reading device emitting an electric or electromagnetic field. More specifically, the invention relates to an RF-ID information support concealed in a spray bottle, e.g., a perfume spray bottle, intended to prevent counterfeiting and theft.

### BACKGROUND

Already known in the prior art is WO 01/06483 which describes a label for bottles functioning as gift wrapping and comprising an opening for attaching the label to the neck of the bottle as well as a fold perpendicular to the longitudinal extension of the label and separating a label holding zone having the opening of a suspended zone of the label. In this system, it is possible to fold back the suspended zone of the label along the fold parallel to the body of the bottle when the label is attached and the suspended zone of the label is provided with elements for receiving objects.

This type of information support has a principal drawback in that it is very easy to remove the article because the information support is positioned on the exterior of the article to be protected. This information support has the function not only of identification especially for payment for the article at check-out, but also as a detection means upon passage through the exit detectors of a store.

It would therefore be advantageous to resolve the drawbacks of the prior art by providing a miniature three-dimensional label which can be produced using plane manufacturing methods used for fabrication of plates used in a condenser. It would also be advantageous to develop a system in which the information support and anti-theft detection means are in the article itself to prevent the removal of the anti-theft and anti-counterfeiting protection. Thus, the removal of the label would not be performed without damaging the product itself.

### SUMMARY OF THE INVENTION

This invention relates to a contactless RF-ID label including an antenna and a computer chip, wherein the antenna extends in three spatial directions.

This invention also relates to a method of manufacturing the contactless label, including etching a conductive metal piece, cutting a support out from the conductive metal, and coiling up a plastic film on which was previously affixed the conductive metal.

### BRIEF DESCRIPTION OF THE DRAWINGS

Better understanding of the invention will be obtained from the description below presented for purely explanatory purposes of one mode of implementation of the invention with reference to the attached drawings:

FIG. 1 is a sectional view of an antenna according to aspects of the invention composed of a metallic film and an insulating substrate;

FIG. 2 is a perspective view of the coiled-up antenna forming a coil;

FIG. 3 is a perspective view of the coil combining a computer chip and a casing that can house and conceal the label;

FIG. 4 is a perspective view of the casing comprising the label and a plastic material that fills it;

FIG. 5 is a sectional view of another aspect of the antenna according to the invention composed of a metallic film and an insulating substrate;

FIG. 6 is a perspective view of the coil forming the antenna represented in FIG. 5 combined with a chip and a casing; and

FIG. 7 is a perspective view of the casing comprising the label and the plastic material that fills it.

### DETAILED DESCRIPTION

It will be appreciated that the following description is intended to refer to specific embodiments of the invention selected for illustration in the drawings and is not intended to define or limit the invention, other than in the appended claims.

This invention enables a high level of protection against the theft as well as the potential counterfeiting of products. This invention is remarkable in its broadest sense in that the contactless RD-ID label comprises an antenna and a computer chip, wherein the antenna of the label extends in the three spatial directions. The antenna preferably comprises a strip of an electrically conductive material such as a metal, e.g., aluminum and the like.

According to a preferred aspect of the invention, the antenna of the label is coiled up on itself to form a coil of cylinders of concentric diameters. The antenna of the label preferably has a radial loop implemented on said strip, e.g., obtained by etching a metal forming the antenna.

According to an aspect of the invention, the antenna is affixed or deposited on a substrate which is nonconductive of electricity, such as a plastic material, e.g., polyterephthalate (PET) and the like. The antenna advantageously has a U shape. Also, the computer chip of the label can be affixed at both ends of the antenna. The label may also be placed in a case or casing. The casing is preferably filled with a plastic material such as, e.g., silicone and the like.

The antenna can advantageously operate at a frequency of 13.56 MHz, 2.45 GHz or an ultrahigh frequency (UHF).

The invention also pertains to a method for manufacturing labels as described above, comprising a step of etching a conductive metal, such as aluminum, a step of cutting out from the conductive metal, a step of coiling a plastic film on which was previously affixed, e.g., by gluing, the conductive metal.

The invention also pertains to the support of the label which can be a bottle or similar object comprising an essentially cylindrical part. The contactless label of the invention can be placed at the level of this cylindrical part. In a more general manner, the invention is based on the use of a label in a container having at least one essentially cylindrical part, wherein the label is placed at the level of this essentially cylindrical part.

The contactless label of the invention can be implemented at any frequency, e.g., at 13.56 MHz. Alternatively, this concept of contactless label can also be applied to other frequencies in which a flat antenna is coiled up to occupy a small space, e.g., by coiling up a dipolar antenna which can operate at an ultrahigh frequency (UHF), a frequency of 2.45 GHz or other operating frequencies of RF/ID labels.

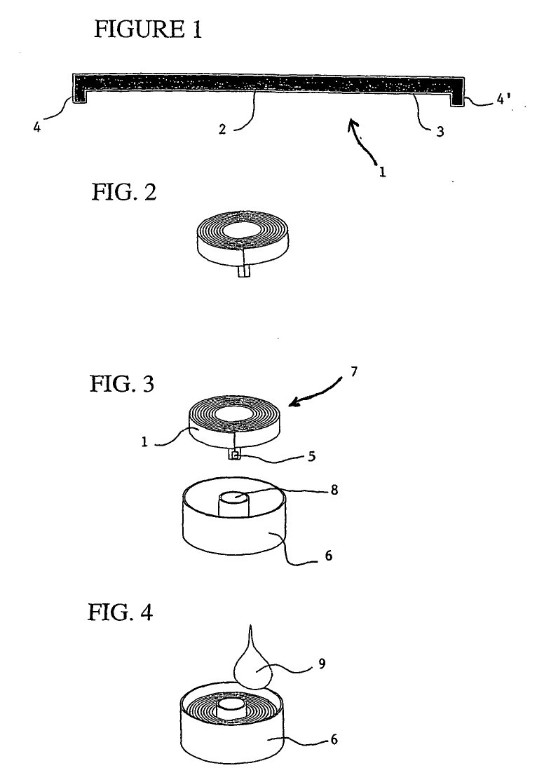

Turning now to the Drawings in general, and FIG. 1 in particular, an antenna 1 comprises a metal strip 2, e.g., made of aluminum, positioned and affixed to an insulating substrate 3 made of plastic, e.g., of polyterephthalate (PET). It is possible to employ other types of plastics or insulating materials to be affixed to a conductive material 2 capable of being deformed to form a spiral or cylinders of concentric diameters. The antenna 1 is in the form of an inverted, flattened “U” with, at its two parallel ends, respectively, two wings 4, 4′, to facilitate connection of an electronic chip 5 to the two wings 4, 4′, forming poles of the antenna 1.

As illustrated in FIG. 2, the antenna 1 is coiled up on itself to form a coil of concentric cylinders and thus a coil whose two wings 4, 4′ of the U-shaped antenna 1 touch each other or are arranged close to each other such that the two wings 4, 4′ can be connected to each other by a bridge or a computer chip 5.

As illustrated in FIG. 3, a computer chip 5 of a size close to that of the two wings 4, 4′ of the antenna 1 is glued or affixed to those of 4, 4′ by any other suitable means well known in the art.

In the example chosen to illustrate selected aspects of the invention, the label 7 is placed in a case 6 or casing of cylindrical form which has approximately the shape and dimensions of the label 7 once the antenna 1 has been folded over on itself. More precisely, the casing 6 has an opening 8 at its center the edges of which have the same height as the casing 6 itself. This opening 8 is provided to be able to insert the casing 6, and possibly to attach it around a cylindrical part of an article, the diameter of which is essentially equivalent to the diameter of the opening 8 of the casing 6.

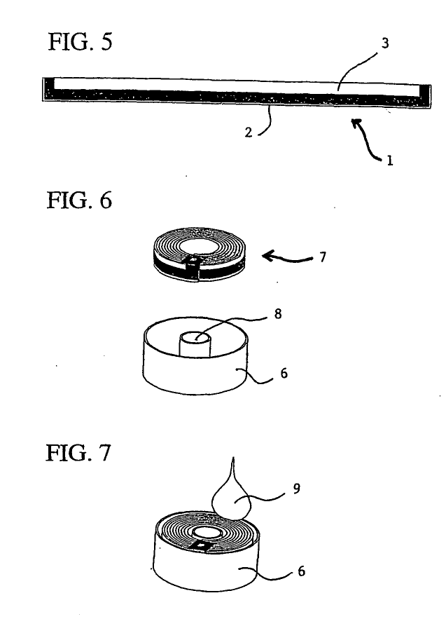

As illustrated in FIG. 4, the label 7 positioned in the case 6 is closed hermetically with a plastic material 9, e.g., made of silicone which is poured on it. Thus, since it is immersed in the liquid, the label 7 becomes inaccessible after the bottling operation. As can be seen in FIG. 5, the antenna 1 comprises a metal strip 2, e.g., made of aluminum, applied to and/or affixed to an insulating substrate 3 made of a plastic material, e.g., polyterephthalate (PET). The antenna 1 has a substrate 3 of flat, rectangular form supporting the metal strip 2 in flattened U shape having both ends, or wings 4, 4′, parallel and of substantially identical dimensions. The principal difference from the mode of implementation shown in FIGS. 1 to 4 is based on the fact that the insulating substrate 3 is present in the form of a rectangle and, unlike the first aspect, does not essentially reflect the dimensions and shape of the metallic conductor 2.

The subsequent operations performed on the antenna to create a label according to the invention are identical to those described in the framework of the first aspect.

The invention is applicable in particular, but not exclusively, to the protection of expensive bottles of perfume (not shown in the figures). In this case, the contactless RF-ID label 7 is ideally positioned at the base of the pump arranged on the neck of the bottle.

We will now assess the advantage represented by the label 7. Because of the pump diameters comprised between 7 and 9 millimeters, it is difficult to create in a conventional manner a contactless label antenna, i.e., by etching a printed circuit or by creating a coil. Moreover, in certain particular fields, e.g., in the context of luxury perfumes, it is particularly important that the contactless label be as unobtrusive as possible so as not to detract from the attractiveness of the perfume bottle.

The contactless label 7 of the invention has a diameter, i.e., the largest diameter of the cylinders or circles formed by the coiling up of the antenna 1, comprised between 4 and 9 millimeters to adapt to the diameter of the cylindrical part.

Thus, the method for the creation of the contactless label of the invention uses a novel technique in the field of contactless labels. Thus, the antenna 1 of the contactless label 7 is created, after etching and cutting, by coiling up a plastic film 3 on which is glued a conductive strip 2 made of a material such as aluminum, a product widely used at present for the creation of flat RF-ID labels. After completion of the coiling up process, the aluminum constitutes the spirals of the antenna 1 and the plastic support constitutes the interspirals. By making adjustments in or modifying the thicknesses of the aluminum 2 and/or the support 3, both of several 1/10 millimeters, as well as the width of the aluminum 2, also of several millimeters, and the number of spirals of the antenna 1, the antenna 1 is easily tuned with the chip condenser 5 at a particular frequency, e.g., of 13.56 MHz. The coiling up of the antenna could obviously also be implemented for any other frequency, such as, e.g., a UHF antenna or a frequency of 2.45 GHz.

As shown above, the antenna 1 connected to the computer chip 5 is then placed in an unobtrusive plastic casing 6, e.g., transparent or white, then filled with resin 9 of the same color, which is resistant to chemical damage from the perfume. This filling material 9 will obviously be selected as a function on the one hand of the content of the bottle or similar container, but also as a finction of its chemical insensitivity with the conductive metal 2 and/or plastic film 3 on which the conductive metal 2 is affixed.

In terms of the attractiveness of the presentation, the external diameter of the casing 6 is essentially identical to that of the pump on which it is placed.

The invention was described above as an example. It is understood that an expert in could implement different variants of the invention without thereby going beyond its

1. A contactless RF-ID label comprising an antenna and a computer chip, wherein the antenna extends in three spatial directions.

2. The label according to claim 1, wherein the antenna is a strip of an electrically conductive material.

3. The label according to claim 1, wherein the antenna is coiled up on itself to form a coil of cylinders of concentric diameters.

4. The label according to claim 2, wherein the antenna has a radial loop implemented on the strip.

5. The label according to claim 1, wherein the antenna is affixed or deposited on an electrically nonconductive substrate.

6. The label according to claim 1, wherein the antenna has a U shape.

7. The label according to claim 1, wherein the computer chip is attached to both ends of the antenna.

8. The label according to claim 1, arranged in a case or casing.

9. The label according to claim 8, wherein the casing is filled with a plastic material.

10. The label according to claim 3, wherein the largest diameter of the cylinders formed by coiling up the antenna is in a range of about 4 and about 9 millimeters.

11. The label according to claim 1, wherein the antenna operates at a frequency of 13.56 MHz.

12. The label according to claim 1, wherein the antenna operates at a frequency of 2.45 GHz.

13. The label according to claim 1, wherein the antenna operates at an ultrahigh frequency (UHF).

14. A method of manufacturing a contactless label according to claim 1, comprising etching a conductive metal piece; cutting a support out from the conductive metal; and coiling up a plastic film on which was previously affixed the conductive metal.

15. A bottle or container comprising an essentially cylindrical part having at least one label according to claim 1.
